(19) United States
(12) Patent Application Publication
(10) Pub. No.: US 2011/0004518 A1
(43) Pub. Date: Jan. 6, 2011

(54) METHOD AND USER DEVICE FOR HANDLING MOBILE ADVERTISING

(76) Inventors: Christer Boberg, Tungelsta (SE); Mats Stille, Bromma (SE); Anders Lindgren, Alvsjo (SE)

Correspondence Address: ERICSSON INC., 6300 LEGACY DRIVE, M/S EVR 1-C-11, PLANO, TX, 75024, US

(21) Appl. No.: 12/920,130

(22) PCT Filed: Mar. 12, 2008
(86) PCT No.: PCT/SE08/50272

§ 371 Date: Aug. 30, 2010

(51) Int. Cl. G06Q 30/00

(52) U.S. Cl. 705/14.52; 705/14.49

(57) ABSTRACT

Personalized advertisements may be provided from a service node to a user, parallel to executing a request from the user device. At the service node, advertisement information may be selected, according to predefined advertisement rules and the applications which are available at the user device, and attached to a response message, sent to the user device in response to the received request. At the user device, the advertisement information is retrieved, structured and stored. A change of state of an application of the user device will initiate an interrogation of the advertisement information, which will result in performing a presentation of an advertisement on the user information, in case such instructions exists. An advertising method, a user device and a service node adapted to execute the suggested method are described.

### TECHNICAL FIELD

The present invention relates to a method for providing personalized advertisements to a user device of a telecommunication network and more particularly for achieving such a method using standardised signalling. The present invention also relates to a user device and a Service node adapted to execute the suggested method.

### BACKGROUND

Today there are a large number of solutions for exchanging advertising data and/or advertising demographic data between a client and a server available on the market.

An advertising system normally determines which advertisement to present to a user on the basis of some kind of user specific information, which typically may be demographic data and/or current context information associated with the user. Some systems also use information relating to the request which has triggered an exchange of advertisement related information.

A problem with existing solutions, such as the one mentioned above, is, however, that they are proprietary and that each solution has its own way of exchanging data between entities.

WO 01 89243 describes a method for obtaining targeted messaging at a User terminal which is connected to a Service node of a communication network. By requesting for delivery of a message, e.g. an advertisement, from the service node, specifying the access type used by the terminal in the request, a user may be provided with an appropriate version of a requested message, in dependence of the access type used by the terminal.

Today internet services are to a large extent financed by advertisements. This allows service providers to offer a lot of services free of charge to their subscribers. In a typical scenario, an end-user visiting a certain Web page may have an advertisement presented on the screen of his user equipment, parallel to browsing the Web page. As a consequence, this end-user will most likely expect new services made available to the public and provided especially to mobile user devices to be for free as well.

In contrast to the common way of financing services in the data communication world, telecommunication operators traditionally charge their subscribers for services on a per call basis. Although the number of registered mobile telephone users presently exceeds 2.5 billion, there is still no advertising technology available, which is adapted for mobile devices.

The different views on how to charge for services which is established among the data communication and telecommunication operators, respectively, may end up in a catch 22 situation, where service developers may tend to hesitate to launch new services for their mobile subscribers, due to slow investments in the needed network infrastructure by the operators. Mobile device manufacturers may also hesitate to invest in new service technology since there is no necessary network infrastructure available. Furthermore, there is a considerable risk that the end-users hesitates to use services accessible on their mobile devices as long as equivalent services adapted for stationary user devices are available for free via the internet.

Obviously there should be a demand for technical solutions which can facilitate for service providers to attract their subscribers to use new services also on their mobile user equipments.

The Open Mobile Alliance (OMA) Session Initiation Protocol for Instant Messaging and Presence Leveraging Extensions (SIMPLE) based presence standard enables operators to offer a variety of presence services to their subscribers. A basic concept of presence is that an end-user, which in this context is typically referred to as a Presentity, can choose to make certain information available to other end-users, commonly referred to as Watchers, via a Presence system. Throughout this document a Presentity will be defined as a presence enabled user device and a user, operating the user device. Correspondingly, a Watcher will be defined as an end-user provided with another presence enabled user device.

A general scenario, describing how presence services may be provided to end-users via a SIP based Presence system, according to the prior art, will now be described with reference to FIG. 1. It is to be understood that this description is limited to the basic principles for exchanging presence related information between end-users engaged in a presence related service, thereby omitting details, such as e.g. specific system nodes and/or additional signalling which is normally required for the execution of complete presence services.

In the figure, a Presentity 100 engaged in a presence service having the intention to make relevant updated presence information available to other end-users, i.e. Watchers, transmit this information to a presence system, which in the figure is represented by a presence server 101, as indicated in a first step 1:1. Typically, this information, which may comprise e.g. the Presentities location or mood, e.g. happy or sad, is transmitted to the presence server 101 in a SIP publish request.

The presence information is then processed by the presence server in conventional manners. Such processing typically comprises an interrogation of presence content rules, stored in a presence server XML Data Management Server (PS XDMS, not shown), as well as filter processing, wherein the filters may be configured to distinguish information of interest from information which is superfluous to the Watchers. Filters may also be set to control when a notification is to be triggered. This procedure is indicated with a next step 1:2. A successful processing is verified to the Presentity in a response message, typically a 200 OK message, as indicated with another step 1:3.

A Watcher 102, having an interest in presence information associated with the Presentity 100, may access the presence system at any time by sending a request, e.g. a SIP subscribe, to the presence server 101 of the presence system. Such a procedure is indicated with a step 1:4. Upon having verified that Watcher 102 is authorized to access the requested information, the updated information will be provided to Watcher 102, typically via a SIP notify, as indicated with a subsequent step 1:5. Watcher 102 may then continuously be provided with additional updated presence information until the subscription is terminated.

In this example, the presence information is provided to the presence system from the user device of the Presentity. Presence systems are, however, normally provided with facilities for handling various types of information provided from different types of sources. These presence sources, which are operating on behalf of the Presentity, may be configured to require manual interaction, or to operate more or less automatically when providing updated presence information to the presence system.

In a presence system, a Watcher may choose to request for all, or specific parts of information associated with a certain Presentity. No mechanism for providing personalized advertisements to end-users engaged in a presence service, is, however, presently known.

### SUMMARY

It is an object of the present invention to address at least some of the problems mentioned above. Further, it is an object of the present invention to provide a method which enables a provider of telecommunication services to provide customized advertisements to user devices, wherein the advertisements depends on the applications, available at the user device.

It is another object of the invention to provide a mechanism for managing advertisements provided at the user device.

According to one aspect, a method is provided for managing advertisements in a user device. In a first step, a request message, comprising at least one identity identifying an application of said user device, is transmitted from the user device a service node of the communication network, said message. In response to the request message, a response message, comprising advertisement information associated with the one or more applications of the user device is received from the service node. Instructions and associated advertisement data retrieved from the advertisement information is then structured and stored at the user device. Subsequent to the structuring and storing of the instructions and advertisement data, a change of state of one of the application of the user device is recognised at the user device. If it is determined that any of the instructions are applicable to the present change of state, a presentation of an advertisement is performed in accordance with the respective instructions.

The presentation of an advertisement may be executed by a central advertisement player of the user device.

According to another aspect, a method is provided for providing advertisements to a user device connected to a communication network. A request message, identifying at least one application of a user device, is transmitted from the user device to a service node. At the service node, advertisement information is selected on the basis of at least advertisement rules and the one or more identified application of the user device. The advertisement information comprises instructions on when to execute a presentation of an advertisement, and associated advertisement data, or at least one link pointing at the relevant advertisement data. The advertisement information is then transmitted to the user device in a response message, transmitted in response to the request.

According to one embodiment, the request according to any of the two aspects is a SIP publish while the response message is a 200 OK or a 486 BUSY.

According to another embodiment, according to any of the two aspects the request is a SIP subscribe while the response message is a SIP notify.

By implementing the suggested method, a service provider may provide customized advertisements to a user engaged in a service session, which typically may be a presence related service session, by utilising the signalling associated with the service session, and, thus, no excessive signalling will be required for the delivery of advertisements to the user device. In addition, the user device may be configured to automatically request for advertisements parallel to requesting for a service to be provided, as well as to automatically present a customized advertisement to the user, one a specific change of state of an application of the user device has been observed.

The claimed invention also refers to a user device, which may be a wireless user device, and a service node, which may be a presence server, for executing the suggested method.

### BRIEF DESCRIPTION OF THE DRAWINGS

The present invention will now be described in more detail by means of exemplary embodiments and with reference to the accompanying drawings, in which:

FIG. 1 schematically illustrates the signalling between entities engaged in a presence service, according to the prior art.

FIG. 2a is a flow chart, illustrating the basic steps for handling advertisements at a user device, according to one aspect.

FIG. 2b is a flow chart, illustrating the basic steps for selecting advertisements for a user device, according to another aspect.

FIG. 3 is a scenario, illustrating the selection and handling of advertisements provided to a user device from a presence server, using SIP signalling, according to one embodiment.

FIG. 4 is an exemplary illustration of how advertisement information may be selected at a service node, according to one embodiment.

FIG. 5 is an exemplary illustration of how advertisement information, selected at a service node may be managed at a user device, according to one embodiment.

FIG. 6 is an illustration of a service node, according to one embodiment.

FIG. 7 is an illustration of a user device managing and storing received advertisement information, according to one embodiment.

FIG. 8 is an illustration of a user device executing a presentation of an advertisement, according to one aspect.

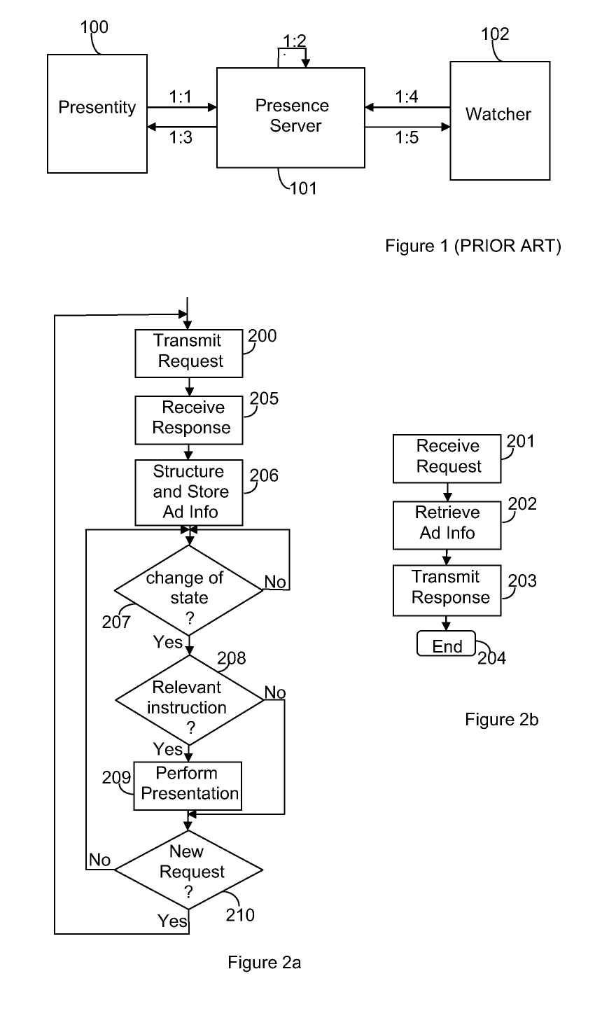

### DETAILED DESCRIPTION

Briefly described, the present invention refers to a method of personalizing the presentation of advertisements on user devices being in connection with a communication network, typically a wireless communication network, and to a service node and a user device adapted to execute such a method. The method also includes steps of managing the advertisements on a user device, and of controlling the play-out of the selected advertisements on the user device.

More particularly, a mechanism is suggested for enabling a controlled presentation of advertisements, wherein the selection of advertisements to be delivered to a user device is based on the applications available on the user device, while the playing out of a specific advertisement is triggered by the present state of any of the applications.

The basic functionality of a SIMPLE based presence system suite very well with the central parts needed for delivery of personalized advertisements to mobile end-users.

In a presence system, a Watcher may request for specific parts of information of a certain Presentity. This is also an important issue for achieving a personalized advertising system, where advertisements can be chosen, based on certain predefined preferences. One important issue for a personalized advertising system is to provide the option of also including information related to a Watcher and/or a Presentity, and to enable the advertising system to use this information as a selection criteria so that the most relevant advertisement can be sent to the Watcher or the Presentity.

According to one embodiment, which will now be described with reference to FIG. 2a, a Presentity, having updated presence information to deliver to a presence server, may transmit this information to the presence server in a SIP request, e.g. a SIP publish request, all according to standard procedures. This is indicated with a first step 200. In addition to the updated presence information, however, the request may also comprise identities, which identify all or some of the services or applications available on the user device. Also this step may be performed utilising standard procedures.

The presence server receiving the SIP request handles the presence information according to common presence procedures, i.e. by interrogating the presence content rules, using filters and by notifying the respective Watchers of the updated presence information via notifications, according to the presence content rules, and the outcome of the filtering. In addition to these common presence procedures, the presence server, being a combined presence server and Advertisement Server, is configured to also retrieve advertisement related information, which will be used for selecting advertisements for the Presentity at the presence server, as well as for controlling the playing-out of an advertisement at the respective user device of the Presentity. This information is assembled into advertisement information, henceforth referred to as Ad info, which is inserted into a SIP response message, sent to the user device in response to the SIP request message.

The response message, now provided also with Ad info, specially adapted for the applications of the user device, is then received by the user device in another step 205. In addition to interpreting the received message as a response to the request, also the Ad info is now accessed by the user device, which is adapted to structure the received information and to store it for later retrieval, as indicated with a next step 206.

Once a change of state, such as e.g. the starting or ending of one of the applications available at the user device occurs, as indicated with a step 207, the respective application will be adapted to initiate an interrogation of the structured information in order to determine whether there are any instructions available which are relevant for the respective change of state. Such in interrogation is illustrated with another step 208. If any relevant instructions are found, these instructions are executed accordingly, resulting in a selection of an advertisement from a group of advertisements for presentation at the user device, as indicated with another step 209. The described procedures may be repeated for new changes of state of any available application, or whenever a new request is sent to the presence server, as indicated with a step 210. A new request may initiate a delivery of a different set of Ad info to the user device, all according to the present advertisement related information.

Although the described embodiment refers to a Presentity, a corresponding procedure may also be applicable for a Watcher, being engaged in a presence related service.

The method described above, seen instead from the perspective of the presence server, will now be schematically described with reference to FIG. 2b.

In FIG. 2b, the request which was transmitted from a user device in step 200 of FIG. 2a, is received at the presence server in a step 201.

At the presence server, the advertisement related information is retrieved according to rules, stipulating how to select relevant instructions and associated advertisements and indicating under which conditions one or more selected advertisements are to be played-out on a user device. This is indicated with another step 202. The selection procedure may also rely on additional information, provided e.g. from the Presentity or from one or more external source. Typically such rules and instructions have been pre-defined e.g. by a service provider or content provider, which wants to offer services free of charge to its subscribers, wherein one or more advertisements, which may be more or less strongly connected to a respective application or service, may be presented to the subscribers when a respective application is providing a presence related service the user of the user device.

In addition to the instructions, the advertisement related information, i.e. the Ad info, also comprises one or more links, e.g. a URL, indicating where to retrieve a specific advertisement, or a group of advertisements, or the actual advertisement, stored in an appropriate format. The advertisement data to which instructions of the advertisement related information refers will from now on be referred to as Ad data.

According to prior art presence solutions, a successful reception of a SIP publish request at a presence server normally results in a response sent to the originator of the SIP publish request via a 200 OK response message. According to the claimed invention this response message will be extended to carry also the Ad info. Thereby, the standardised presence signalling will be used also for the proposed advertising purposes.

Once advertisement related information has been selected at the presence server it is provided to the Presentity together with instructions, indicating under which conditions the advertisement is to be presented at the user device. This information is provided to the user device in a response message, as indicated with a subsequent step 203.

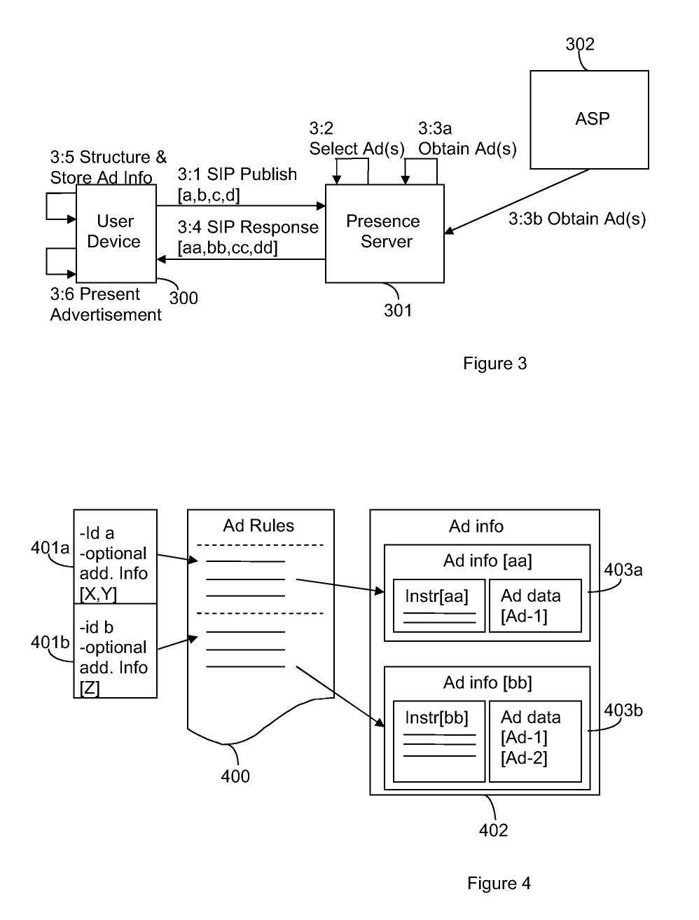

A method of providing Ad info to a user device, in this case a Presentity, engaged in a presence related service, according to one embodiment, will now be described in further detail with reference to FIG. 3.

The method according to this embodiment refers to a mechanism which allows a service provider to have a specific advertisement presented to a Presentity, when the Presentity is engaged in a presence related service. The selected advertisement may e.g. be presented when the Presentity initates and/or terminates a Push-To-Talk (PTT) session, an IP-telephony call, a video share, an Instant Messaging session, a video call, a game session, or when the Presentity is making a presence modification, such as e.g. changing mood from happy to cinema. The advertisement may also be instructed to be presented at certain intervals during the execution of a respective service session.

In a first step 3:1 of FIG. 3, a Presentity having presence related information to transmit to a presence system, represented by presence server 301 in the figure, transmits this information from a user device 300 in a request, typically a SIP publish request. In addition to the presence information, the request also comprises the identities a, b, c and d, identifying the applications A, B, C and D, available at the user device of Presentity 300.

The presence server 301, comprises means for retrieving and handling the presence information in order to execute the requested presence related service in a conventional manner. It is also adapted to analyse the received content and to obtain Ad info, which may be pre-stored by the presence server 301, or retrievable from one or more external sources, upon receiving a request.

According to this exemplary embodiment, the Ad info comprises instructions associated with each application, identified in the request message, as well as relevant Ad data, executable at the user device, or one or more links, linking to the relevant advertisements.

In another step 3:2, relevant Ad info is selected, using some selection criteria. Such criteria may be based on rules and/or additional stored information, or information retrieved from one or more external sources. The criteria may also rely on a combination of the described alternatives. It is to be understood that the advertisement rules, having a purpose which corresponds to the presence content rules, presently stored in the PS XDMS of a typical presence system, have been provided to the presence system in advance, typically via uploading from a content provider.

In step 3:3a the selected Ad info is obtained from a storage means of the presence server 301, wherein for each identity, identifying a specific application, there is pre-defined information available, which together forms the Ad info relevant for user device 300.

Alternatively, the selected Ad info may instead be retrieved from one or more external sources, such as e.g. an Application Service provider (ASP) 302, as indicated with the alternative step 3.3b in the figure. One of the procedures, described with steps 3.3a and 3.3b, or a combination of both procedures, may be used for retrieving updated Ad info each time a request is received from the user device.

Once retrieved from a storage means of the presence server 301 and/or one or more external entities, Ad info defined for all the relevant services A, B, C and D, indicated as aa, bb, cc and dd, respectively in the figure, is inserted into a response message, typically a 300 OK, if the request was successfully processed by the presence server 301. In case of failure to execute the request, a response message, such as e.g. a 486 BUSY, will instead be sent to the user device. In such a case, the advertisements selected for the user device may in one way or the other be associated with the fact that a requested service could not be executed.

If the Presentity subscribes to its own presence data, the presence server may instead be adapted to include the Ad info in a multipart body, together with the requested presence data.

The SIP response message, now provided with the Ad info, is then transmitted to the user device 300 in another step 3:4. At the user device 300, the information of the response message is interpreted accordingly and the attached Ad info is handled and stored in a structured manner, enabling the activations and/or deactivations of the applications of the user device 300 to control how at least some advertisements will be presented to the user of user device 300, as indicated with a step 3:5.

Once it has been recognised that a change of state for which specific instructions have been specified in the Ad info has occurred, these instructions are followed, and the respective advertisement will be presented to the user of the user device, according to these instructions. This final step is indicated with step 3:6.

As an alternative to transmitting the identities, identifying applications of the user device in a SIP request message, and the associated Ad info in a response message, the identities could instead be sent to the presence server in a SIP subscribe request, wherein the corresponding Ad info could instead be sent to the user device in a notification, i.e. a SIP notify. Also this way of signalling the identities and Ad info will rely on already existing signalling.

The example referred to above, describing the configuration of a user device of a Presentity may be applicable also for an end-user acting instead as a Watcher. In such a case, the request message sent in step 3:1 may instead be a SIP subscribe, while the SIP response message sent in step 3:4 may be a SIP notify.

The selection of Ad info at a Service node, such as e.g. a presence server, may be described as illustrated in the example of FIG. 4, where pre-configured rules, referred to as Ad rules 400, specifies selection criteria for how to select Ad info for a user device. In the figure, the identities of the applications A and B, Id a and Id b, respectively, of a user device from which a request has been sent are used as input parameters 401a and 401b, respectively, when interrogating the Ad rules for determining which Ad info to select for the user device.

Apart from the application specific identities, Id a and Id b, additional information, indicated as X and Y for and as Z, respectively, which is to be considered when selecting relevant Ad info, may be provided in the request received from the user device, and/or from another data source, and may be used as additional selection criteria.

In this example, the parameters 401a, associated with application A, will result in the selection of Ad info record, Ad info[aa], 403a comprising relevant instructions, Instr[aa] and associated Ad data, “Ad-1”, while parameters 401b, associated with application B, will result in Ad info defined as Ad info[bb] 403b, comprising another set of relevant instructions, Instr[bb], and associated Ad data, “Ad-1” and “Ad-2”.

The two records Ad info[aa] 403a and Ad info[bb] 403b are assembled into Ad info 402, which is attached to a response message and provided to the user device, as described previously in this document.

At the user device, the Ad info is structured and stored so that a presentation of an advertisement can be invoked automatically, once a state of an application for which there are instructions defined is recognised.

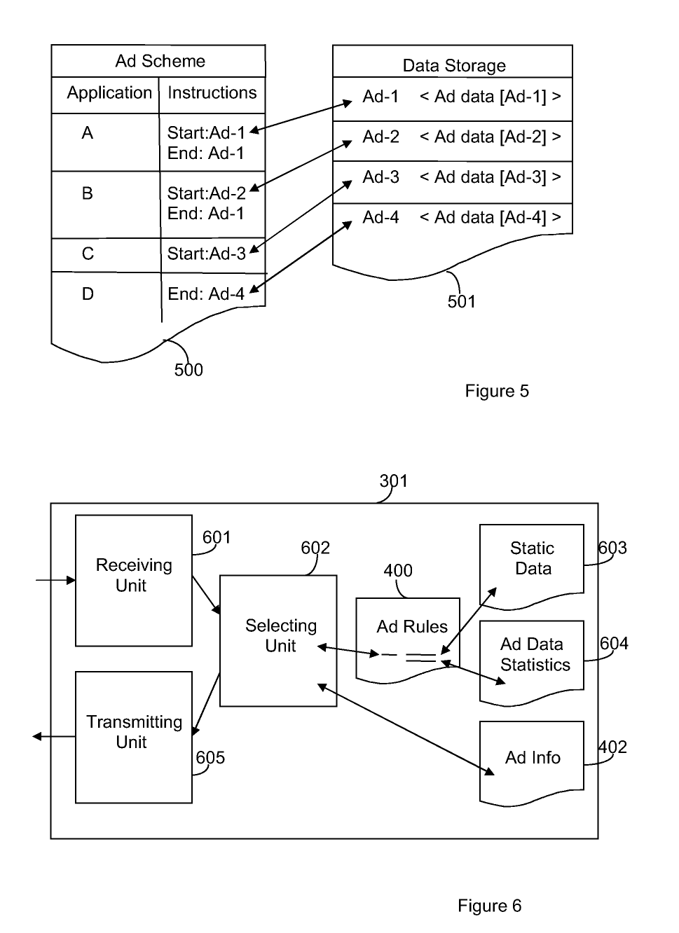

An exemplary structure of an advertisement scheme (Ad scheme), i.e. a scheme comprising all instructions, relevant for one or more of the applications of a user device, and retrieved from the Ad info of a request, delivered from a service node, as described above, may be configured as illustrated in FIG. 5.

The Ad scheme 500 of FIG. 5, provided at the user device, enables a controlling function of the user device to interrogate relevant instructions whenever applicable, e.g. whenever a state of an application for which stored instructions are recognised. The instructions of Ad scheme 500 comprises search keys Ad-1,Ad-2,Ad-3,Ad-4, for retrieving relevant Ad data, which typically may have been stored in a Data Storage 501 of the user device, as indicated in the figure.

The Ad scheme 500 of FIG. 5 comprises instructions specified for the four Applications A, B, C and D. The instructions of the Ad scheme 500 indicate that an advertisement, identified with search key or identity “Ad-1” is to be presented on the user device both when application A starts and when it ends. Another advertisement, identified as “Ad-2”, is, according to the Ad scheme 500, set to be played out when application B starts, while AD-1 is to be played out on the user device also upon ending application B. For application C only an instruction to play-out a third advertisement, identified in the figure as “Ad-3”, has been defined. The third advertisement is set to be played out when application C ends, while a fourth advertisement, identified as “Ad-4”, is to be played out when application D ends.

A notification initiated by an application will trigger the interrogation of the Ad scheme. Starting application A, will for example result in the retrieving of Ad data, identified as “Ad-1”, and the execution of the corresponding advertisement, either by the application itself, or by a central unit, which in this document is referred to as an Ad player.

A Service node, such as e.g. a presence server, adapted to provide personalized advertisements to end-users, according to one exemplary embodiment, will now be described in more detail with reference to FIG. 6.

It is to be understood that although the described service node is configured as one single node, adapted to execute a number of generic functions, the described example only illustrates one possible way of providing the suggested method and service node. It is also to be understood that the described service node, which, if configured as a presence server can also be referred to as a combined presence/advertisement server, is only one node out of a plurality of additional nodes, which will be necessary for providing services to the user of a user device. General system architecture in this field is, however, commonly known to the person skilled in the art, and, thus, information on this level will be omitted in this document. For the same reason, means or units which are of no relevance for the understanding of the described invention but which may be necessary for providing efficient operability in a conventional service node have also been omitted for simplicity reasons.

The presence server 301 of FIG. 6 comprises a receiving unit 601, comprising means for receiving and recognising an extended request message, transmitted from a user device, e.g. according to FIG. 3. The presence server 301 also comprises a selecting unit 602, adapted to retrieve the extended information of the request message, and to use this information, typically in combination with additional information, typically user or user device specific information, to select relevant Ad info to be delivered to a user device. The selection procedure relies on a matching of the retrieved information against the advertisement rules, Ad rules 400, which typically are obtained from a data storage (not shown) of the presence server 301. When considering the Ad rules 400, the retrieved information comprises the identities a, b, c and d, of FIG. 3, identifying applications A, B, C, and D, respectively, of the user device.

The selecting unit 602 may also have access to additional information stored at, or in association to the presence server. Such information may comprise static data 603, which may refer to the user device and/or the User of the user device and/or statistics 604 about the Ad data. The statistics may comprise information, such as e.g. the latest retrieved, the latest transmitted and/or the most frequently transmitted advertisement. When matching the Ad rules 400 against the information associated with the Watcher or Presentity, a match may preferably indicate one or a group of specific Ad info identities, each of which refers to a specific set of updated Ad info 402, which is to be selected from a storage (not shown) of the presence server 301, or from an external source (not shown).

The presence server 301, also comprises a transmitting unit 605 for transmitting the response message, comprising the selected Ad info, to the user device.

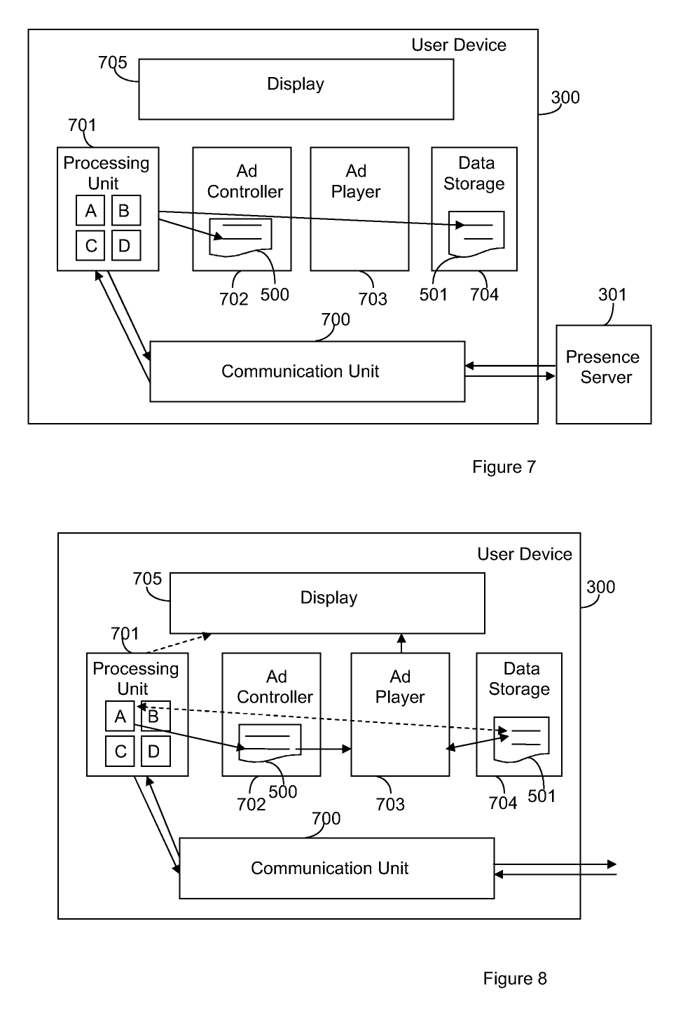

A user device according to one exemplary embodiment will now be described in further detail with reference to the block diagrams of FIGS. 7 and 8, where FIG. 7 illustrates information flows as they may appear between different units or means on the user device when receiving Ad info in a response, while FIG. 8 illustrates information flows for determining if a play-out of an advertisement is to be executed and for activating the play-out of the advertisement.

It is to be understood that the focus of FIGS. 7 and 8 is to illustrate a user device adapted to receive and handle Ad info, and thus, means or units, as well as signalling flows, which are not necessary for the understanding of these and associated procedures, but which may be required for enabling a conventional user device to operate properly, have been omitted for simplicity reasons.

The user device 300 of FIG. 7 have a communication unit 700, comprising conventional means or functions such as e.g. radio and packet communication engines and codecs, which are necessary for enabling wireless communication between the user device 300 and other network entities, in this example represented by presence server 301. The user device 300 also comprises a processing unit 701, adapted to manage one or more applications, here indicated as applications A, B, C and D.

An request, e.g. a SIP publish request, comprising updated publication information, is generated by the processing unit 701. Depending on the present configuration, the identities of some or each application of the user device 300, is also added to the request, which is then provided from the processing unit 701 to the communication unit 700 from where it is transmitted to the presence server 301. A process, as the one described above, for generating and transmitting an extended SIP request message, may be executed according to know procedures.

The presence server 301, receives the request, in a process which may be achieved according to well known procedures. In addition to handling presence information, the presence server 301 evaluates available Ad rules and any additional information in order to retrieve the relevant Ad info, which is then added to an extended response message, which is then sent to the user device 300.

The response message, e.g. a 200 OK, provided with the Ad info, is received by the communication unit 700 of the user device 300, in a conventional manner. In addition to processing the response message, the processing unit 701 is also adapted to recognise and retrieve the Ad info from the response message, as well as to forward this information to a function adapted to manage the content of the Ad info. Such a function is referred to as an Ad controller 702, which structures the Ad info into an appropriate format so that both the instructions and the associated Ad data can be retrieved and processed whenever needed, according to the application activities.

The Ad controller 702 stores the instructions of the Ad info in a structured format, typically by creating and maintaining a scheme, here referred to as an Ad scheme 500, as indicated earlier with reference to FIG. 5. The Ad info, and thus, the Ad scheme 500 will typically comprise application related instructions for each application for which at least one specific advertisement has been defined.

As illustrated in FIG. 5 as well, the Ad info also comprises one or more executable advertisements, provided in an appropriate format, i.e. Ad data or one or more links, indicating where to retrieve the relevant Ad data, or a combination of both. The processing unit 701 is also adapted to retrieve such content and to store it in a Data Storage 704 for later retrieval by a function adapted to perform a presentation of the advertisement. According to this exemplified embodiment, such a function is provided by a specific Ad player 703, especially adapted to present an advertisement on the user device when indicated in an instruction of the pre-determined Ad scheme. The advertisement is presented via the display 705 of the user device 300, typically in combination with other reproducing means, such as the loud speaker.

In addition to instructions indicating when the advertisements are to be presented, e.g. whether to play-out an advertisement in association with an invocation, a termination of, or at specified time intervals during the execution of an application and a service, the Ad info may also include more detailed advertisement related information, such as e.g. the length of an advertisement, which may be used for providing more detailed conditional instructions. An advertisement, not exceeding a certain length, may e.g. be set to be played out during periods of inactivity when an application is executing a specific service. Other conditional rules may be based e.g. on the time of the day, and/or one or more age control parameters.

Below is an example of how Ad info, provided as an extension document may be organised. This exemplary document follows the Presence Information Data Format (PIDF) standard, which is the standardised format for presence. The relevant Ad data has been linked to each element. By adding such an Ad info document into a response message which is then sent to the user device for storage, the presence server will be able to use a standardized format when instructing a controlling function of the user device, such as e.g. the Ad controller defined in this document, how to handle each advertisement in relation to the application/services handled by the user device.

The exemplified document described below comprises instructions that relates to two applications or services, identified by identifiers “a1” and “a2”, and to the presence mood of a user, identified as user “p1”.

```
<?xml version=”1.0” encoding=”UTF-8”?>
>presence smlns=”urn:ieft:params:xml:ns:pidf”
xmlms:pdm=”urn:ietf:params:xml:ns:pidf:data-model”
xmlms:rpid=”urn:ietf:params:xml:ns:pidf:rpid”
xmlms:op=”urn:oma:params:xml:ns:pidf:oma-pres”
xmlms:eric=”urn:ericsson-:xml:ns:pidf:adinfo”
entity=”sip:lasse@example.com”>
>tuple id=”a1”>
  <status>
  <basic>open>/basic>
  </status>
  <op:service-descision>
  <op:service-id>org.openmobilealliance:PoC-
  session</op:service-id>
  <op:version>1.0</op:version>
  <op:serviceid>http://adserver.com/ad1
  </op:adlink>
<eric:adplay>start,stop</op:adplay># play at
start/stop of this service
<op/:service-description>
</tuple>
<tuple id=”a2”>
  <status>
  <basic>open</basic>
  </status>
  <op:service-description>
  <op:service-id>org.openmobilealliance:IM-pager-
  mode</op:service-id>
  <op:version>1.0</op:version>
  <eric:adlink>http://adserver.com/ad2>/op:adlink>
  >eric:adplay>start</op:adplay># play at start of
  this service
  </op:service-description>
  </tuple>
  <pdm:person id=”p1”>
<eric:adlink>http://adserver.com/ad3</op:adlink>
<eric:adplay>anytime</op:adplay> # play at anytime
suitable
<activities>
  <vacation/>
  <eric:adlink>http://adserver.com/ad4</op:adlink>
  <eric:adplay>in-relation</op:adplay># play when
  presence data is set
  <breakfast/>
  <eric:adlink>http://adserver.com/ad5</op:adlink>
  <eric:adplay>in-relation</op:adplay> # play when
  presence data is set
  </activities>
  </pdm:person>
  </presence>
```

This example includes links to the respective advertisements. As already mentioned earlier, however, the actual advertisement, i.e. the Ad data, may instead be included in the document which is added to a response message.

Once Ad info has been received by the user device and structured into the specified format, an advertisement may be presented to the user, all according to the stored instructions.

FIG. 8 illustrates another exemplary information flow between the means or units of the user device recently presented with reference to FIG. 7. In FIG. 8, however, focus is instead on the interaction between the units in a situation where a change of state has occurred for any of the applications A, B, C or D.

According to the described embodiment, the processing unit 701 is adapted to notify the Ad controller 702 whenever a change of state e.g. an invoking or terminating of an application, has occurred. If relevant instructions exists, the Ad controller 702 is adapted to invoke the Ad player 703, by providing a relevant Advertisement Identity (Ad Id), identifying an advertisement that is to be presented by the Ad player 703, all according to the relevant instructions. The Ad player 703 is adapted to respond to this trigger by retrieving the executable Ad data from the data storage 704, using the retrieved Ad Id as a search key.

Once the identified Ad data has been provided to the Ad player 703, the Ad player is further adapted to present the advertisement via the display 705, typically in combination with other reproducing means of the user device 300.

In an alternative embodiment, one or more applications of the processing unit 701, may be adapted to recognise and execute a presentation of advertisements directly on the reproducing means. The applications may e.g. be configured with software implemented functionality, corresponding to the Ad controller 702 and the Ad player 703 described above, which may be adapted both to handle and to process arriving Ad info. Such an alternative solution is indicated with the two dotted arrows, wherein the Processing unit manages to perform a controlled presentation of advertisements, by interacting directly with the reproducing means, i.e. display, loud speaker etc. and the Data Storage, when an advertisement is to be played out.

A typical strategy for using the suggested selective advertisement mechanism, is to pre-define rules for advertisement presentation, enabling the user device to present a chosen advertisement to a user when the user starts, uses and/or terminates a service that in one way or the other is connected to, or associated with, the respective topic of the advertisement.

In one exemplary scenario a user may e.g. have one advertisement presented on the display when a specific service is about to start and another advertisement when the service has terminated.

In another scenario, a failure to set-up a required service, may result in a presentation of an advertisement, advertising upgrading of software which may provide more reliable services.

It is to be understood that the user device and the service node comprises generic functions which, although described according to one exemplary embodiment, may be implemented according to a variety of alternative embodiments, without leaving the intended inventive concept.

While the invention has been described with reference to specific exemplary embodiments, the description is generally only intended to illustrate the inventive concept and should not be taken as limiting the scope of the invention, which is defined by the appended claims.

Although presented in the context of presence services provided by a presence server, it is to be understood that the method and the mechanisms described with reference to the enclosed embodiments is not restricted to this particular field, but can also be implemented for other services provided via a communication network, and for other network configurations, including other types of service nodes than presence servers.

1. A method in a user device of managing advertisements via a SIP based presence system, said user device being connected to a service node of a communication network, wherein said method, executed by the user device, comprises the following steps:
transmitting a request message to said service node, said message comprising at least one identity identifying an application of said user device,
receiving a response message from said service node, said response message comprising advertisement information associated with said at least one application,
structuring and storing instructions and associated advertisement data retrieved from said advertisement information,
recognising a change of state of said at least one application,
determining if any of said instructions are applicable to said change of state, and
performing a presentation of an advertisement in accordance with said instructions and said associated advertisement data in case applicable instructions were found.

2. The method according to claim 1, wherein said advertisement information comprises advertisement data or at least one link pointing at said advertisement data, said advertisement data comprising data executable as an advertisement at said user device.

3. The method according to claim 1, wherein said performing step is executed by an advertisement player of said user device.

4. The method according to claim 1, wherein said storing step comprises the steps of:
storing said retrieved instructions together with references to the respective advertisement data, and
storing said advertisement data in a data storage.

5. A method of providing advertisements to a user device connected to a communication network via a SIP based presence system, wherein said method comprises the following steps, executed by a service node of said communication network:
receiving a request message from said user device, said message identifying at least one application of said user device,
selecting advertisement information at least on the basis of advertisement rules and said at least one identified application, said advertisement information comprising instructions for said user device on when to execute a presentation of an advertisement and associated advertisement data or at least one link pointing at the relevant advertisement data, and
transmitting a response message comprising said advertisement information to said user device.

6. The method according to claim 5, further comprising the step of:
retrieving and storing said advertisement rules prior to performing said selecting step.

7. The method according to claim 5, wherein said advertisement rules comprise conditional rules for how to select advertisement information relevant for said at least one application of said user device.

8. The method according to claim 7, wherein said advertisement information associates at least one advertisement with at least one of said one or more applications.

9. The method according to claim 7, wherein said advertisement information comprise instructions, said instructions instructing said user device when to execute a presentation of one of said at least one advertisement.

10. The method according to claim 9, wherein said advertisement information comprises said instructions and associated advertisement data, said advertisement data comprising data required for executing at least one presentation of an advertisement at said user device and/or at least one link pointing at said data.

11. The method according to claim 10, wherein said advertisement data and/or said advertisement rules are uploaded from said content provider in a SIP notify, said SIP notify being transmitted to said service node in response to a SIP publish.

12. The method according claim 10, wherein said selecting step is also based also on advertisement data statistics specifying statistics on advertisement data provided to said service node.

13. The method according to claim 12, wherein said advertisement statistics comprises information on one or more of: last transmitted advertisement data, most frequently transmitted advertisement data, time since last transmitted advertisement data.

14. The method according to claim 1, wherein said request message is a SIP publish and said response message is any of a 200 OK or a 486 BUSY.

15. The method according to claim 1, wherein said request message is a SIP subscribe and said response message is a SIP notify.

16. The method according to claim 15, wherein said SIP notify is triggered by any of: a poll, a timer, or a storing of new advertisement data at the service node.

17. A user device connected to a communication network for managing advertisements via a SIP based presence system, said user device comprising:
a transmitting unit for transmitting a request message to a service node, said message identifying at least one application of said user device,
a receiving unit for receiving a response message from said service node, said response message comprising advertisement information associated with said at least one application,
an advertisement controller adapted to structure and to store instructions and associated advertisement data retrieved from said advertisement information, and
a processing unit adapted to manage said at least one application and to notify said advertisement controller
upon having recognised a change of state of any of said at least one application, wherein said advertisement controller is adapted to determine if any instructions are applicable to said change of state and to initiate a presentation of an advertisement in accordance with said instructions in case applicable instructions are found.

18. The user device according to claim 17, wherein said application for which said state has changed is adapted to perform said presentation.

19. The user device according to claim 17, further comprising an advertisement player adapted to perform said presentation.

20. The user device according to claim 17,
wherein
said advertisement controller is adapted to store said retrieved instructions together with references to the respective advertisement data, and said advertisement data in a data storage.

21. The user device according to claim 17, wherein said user device is any of a cellular telephone, a PDA, a laptop or a PC.

22. A service node of a communication network for providing advertisements to a user device connected to said communication network via a SIP based presence system, said method comprising:
a receiving unit for receiving a request message from the user device, said message identifying at least one application of said user device,
a selecting unit adapted to select advertisement information at least on the basis of advertisement rules and said at least one application and predefined, said advertisement information comprising instructions for said user device on when to execute a presentation of an advertisement and associated, advertisement data or at least link pointing at the associated advertisement data, and
a transmitting unit for transmitting a response message comprising said advertisement information to said user device.

23. The service node according to claim 22, wherein said selecting unit is further adapted to retrieve said advertisement rules prior to selecting said advertisement information.

24. The service node according to claim 22, wherein said selecting unit is adapted to interpret said advertisement rules as conditional rules specifying how to select advertisement information relevant for said at least one application of said user device.

25. The service node according to claim 22, wherein said selecting unit is adapted to select said advertisement information on the basis of said advertisement rules, said advertisement rules comprising a link to relevant instructions and associated advertisement data, said advertisement data comprising data required for executing a at least one presentation of an advertisements at said user device and/or at least one link pointing at said data.

26. The service node according to claim 22, wherein said selecting unit is adapted to upload the advertisement data and/or advertisement rules from a content provider.

27. The service node according to claim 26, wherein said selection unit is adapted to upload the advertisement data and/or advertisement rules from said content provider via a SIP notify, said SIP notify being transmitted in response to a SIP publish.

28. The service node according to claim 22, wherein said selecting unit is further adapted to select advertisement information based also on advertisement statistics specifying statistics of said advertisement data.

29. The service node according to claim 22, wherein said receiving unit is adapted to receive a request message sent as a SIP publish and the transmitting unit is adapted to transmit the response message as any of a 200 OK or a 486 BUSY.

30. The service node according to claim 22, wherein said receiving unit is adapted to receive the request message as a SIP subscribe and said transmitting unit is adapted to transmit said response message as a SIP notify.

31. The service node according to claim 30, wherein said selecting unit is adapted to use any of a poll, a timer, or a storing of new advertisement data at the service node the transmission of a SIP notify as a trigger for transmission of a SIP notify via said transmitting unit.

32. The service node according to claim 22, wherein said service node is a presence server.
